(19) United States
(12) Patent Application Publication
(10) Pub. No.: US 2025/0141333 A1
(43) Pub. Date: May 1, 2025

(54) CONTROLLER WITH AVERAGE CURRENT BALANCING CIRCUIT

(71) Applicant: TEXAS INSTRUMENTS INCORPORATED, Dallas, TX (US)

(72) Inventors: Seetha Seetharaman, Freising (DE); Puneet Sareen, Freising (DE)

(21) Appl. No.: 18/495,934

(22) Filed: Oct. 27, 2023

(51) Int. Cl. H02M 1/00; H02M 1/088; H02M 3/158

(52) U.S. Cl. CPC H02M 1/0009; H02M 1/088; H02M 3/158

(57) ABSTRACT

A circuit includes a compensation terminal, a current feedback terminal, a voltage feedback terminal, a reference voltage terminal, a modulator, an error amplifier, and average current balancing circuitry. A first input of the modulator is coupled to the current feedback terminal. A first input of the error amplifier is coupled to the voltage feedback terminal. A second input of the error amplifier is coupled to the reference voltage terminal. An output of the error amplifier is coupled to the compensation terminal. A first input of the average current balancing circuitry is coupled to the output of the error amplifier and the compensation terminal. A second input of the average current balancing circuitry is coupled to the current feedback terminal. An output of the average current balancing circuitry is coupled to a second input of the modulator.

### BACKGROUND

Direct current (DC)-to-DC converters and alternating current (AC)-to-DC converters, which may be referred to collectively as power converters, are widely employed in devices of today to perform power conversion. Generally, power converters receive a nominal voltage from a power source, such as a battery, and provide a regulated output voltage at one or more voltage levels. A variety of power converters and topologies can be employed to perform this power conversion. For example, buck converters, boost converters, and buck-boost converters are three basic types of power converter technologies.

### SUMMARY

A circuit includes a compensation terminal, a current feedback terminal, a voltage feedback terminal, a reference voltage terminal, a modulator, an error amplifier, and average current balancing circuitry. The modulator has a first input, a second input, a first output, and a second output. The first input of the modulator is coupled to the current feedback terminal. The error amplifier has a first input, a second input, and an output. The first input of the error amplifier is coupled to the voltage feedback terminal. The second input of the error amplifier is coupled to the reference voltage terminal. The output of the error amplifier is coupled to the compensation terminal. The average current balancing circuitry has a first input, a second input, and an output. The first input of the average current balancing circuitry is coupled to the output of the error amplifier and the compensation terminal. The second input of the average current balancing circuitry is coupled to the current feedback terminal. The output of the average current balancing circuitry is coupled to the second input of the modulator.

A system includes a voltage input terminal, a voltage output terminal, a first switching circuit, a first inductor, a first current sensor, a first compensation terminal, a first current feedback terminal, a first voltage feedback terminal, a first reference voltage terminal, a first modulator, a first error amplifier, and first average current balancing circuitry. The first switching circuit is coupled to the voltage input terminal and the voltage output terminal. The first inductor is coupled to the first switching circuit. The first current sensor is coupled to the first inductor. The first current feedback terminal is coupled to the first current sensor. The first voltage feedback terminal is coupled to the voltage output terminal. The first modulator has a first input, a second input, a first output, and a second output. The first input of the first modulator is coupled to the first current feedback terminal. The first output of the first modulator is coupled to a first control terminal of the first switching circuit. The second output of the first modulator is coupled to a second control terminal of the first switching circuit. The first error amplifier has a first input, a second input, and an output. The first input of the first error amplifier is coupled to the first voltage feedback terminal. The second input of the first error amplifier is coupled to the first reference voltage terminal. The output of the first error amplifier is coupled to the first compensation terminal. The first average current balancing circuitry has a first input, a second input, and an output. The first input of the first average current balancing circuitry is coupled to the output of the first error amplifier and the first compensation terminal. The second input of the first average current balancing circuitry is coupled to the first current feedback terminal. The output of the first average current balancing circuitry is coupled to the second input of the first modulator.

A circuit includes a compensation terminal, a current feedback terminal, a voltage feedback terminal, a reference voltage terminal, a modulator, an error amplifier, and average current balancing circuitry. The modulator is configured to receive a first feedback signal indicating a feedback current from the current feedback terminal, receive an adjusted compensation signal, and output a modulated signal based on the first feedback signal and the adjusted compensation signal. The error amplifier is configured to receive a second feedback signal indicating a feedback voltage from the voltage feedback terminal, receive a reference signal from the reference voltage terminal, and output a compensation signal at the compensation terminal based on a comparison between the second feedback signal and the reference signal. The average current balancing circuitry is configured to receive the compensation signal, receive the first feedback signal from the current feedback terminal, and output the adjusted compensation signal to the modulator based on the compensation signal and the first feedback signal.

### BRIEF DESCRIPTION OF THE DRAWINGS

FIG. 1 is a circuit diagram of some examples of a circuit for controlling power electronics.

FIG. 2 is a circuit diagram of some examples of a system including the circuit of FIG. 1.

FIG. 3 and FIG. 4 are diagrams of some examples of signals corresponding to the system of FIG. 2.

FIG. 5 is a circuit diagram of some other examples of a circuit for controlling power electronics.

FIG. 6 and FIG. 7 are a circuit diagrams of some examples of average current balancing circuitry of the circuit of FIG. 5.

FIG. 8 is a diagram of some examples of signals corresponding to FIG. 6.

FIG. 9 is a circuit diagram of some other examples of a circuit for controlling power electronics.

FIG. 10A, FIG. 10B, and FIG. 10C are a circuit diagram of some examples of average current balancing circuitry of the circuit of FIG. 9.

FIG. 11 is a circuit diagram of some other examples of a circuit for controlling power electronics.

FIG. 12A and FIG. 12B are a circuit diagram of some examples of a system including the circuit of FIG. 11.

FIG. 13 and FIG. 14 are plots of some examples of signals corresponding to the system of FIG. 12A and FIG. 12B.

The same reference numbers or other reference designators are used in the drawings to designate the same or similar (functionally and/or structurally) features.

### DETAILED DESCRIPTION

The following description provides many different examples for implementing different features of the provided subject matter. Specific examples of components and arrangements are described below to simplify the present description. The drawings are not drawn to scale.

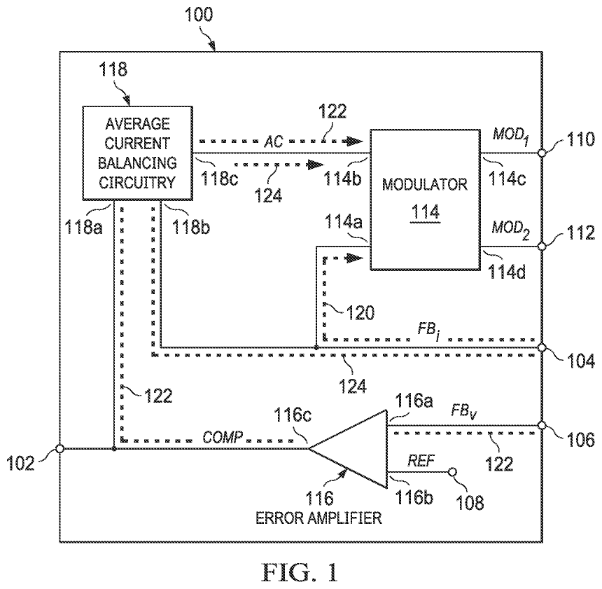

FIG. 1 is a circuit diagram of some examples of a circuit 100 for controlling power electronics (e.g., DC-to-DC converters, voltage regulators, or the like). The circuit 100 includes a compensation terminal 102, a current feedback terminal 104, a voltage feedback terminal 106, a reference voltage terminal 108, a first output terminal 110, a second output terminal 112, a modulator 114, and an error amplifier 116. Circuit 100 may be formed on a single integrated chip (IC). Thus, circuit 100 may be referred to as chip 100.

A first input 114a of the modulator 114 is coupled to the current feedback terminal 104. A first output 114c of the modulator 114 is coupled to the first output terminal 110. A second output 114d of the modulator 114 is coupled to the second output terminal 112. The modulator 114 is coupled in a first feedback path 120 which includes the current feedback terminal 104 and the first input 114a of the modulator 114. The modulator 114 is configured to receive a current feedback signal FB; indicating a feedback current from the current feedback terminal 104.

A first input 116a of the error amplifier 116 is coupled to the voltage feedback terminal 106. A second input 116b of the error amplifier 116 is coupled to the reference voltage terminal 108. An output 116c of the error amplifier 116 is coupled to the compensation terminal 102. The error amplifier 116 is configured to receive a voltage feedback signal FBᵥ indicating a feedback voltage from the voltage feedback terminal 106, receive a reference signal REF from the reference voltage terminal 108, and output a compensation signal COMP at the output 116c and the compensation terminal 102 based on a comparison between the voltage feedback signal FBᵥ and the reference signal REF.

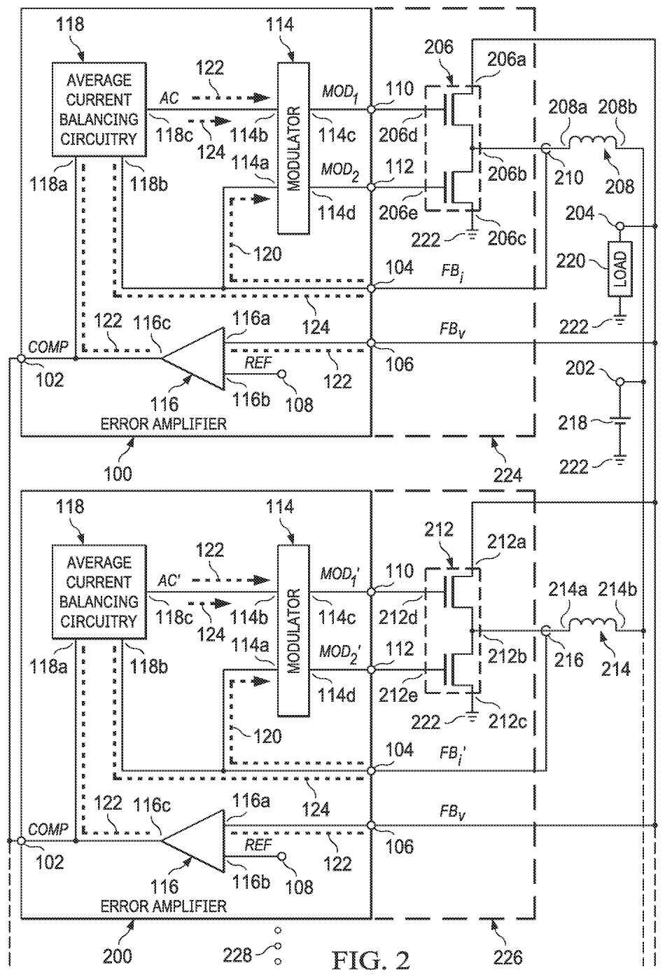

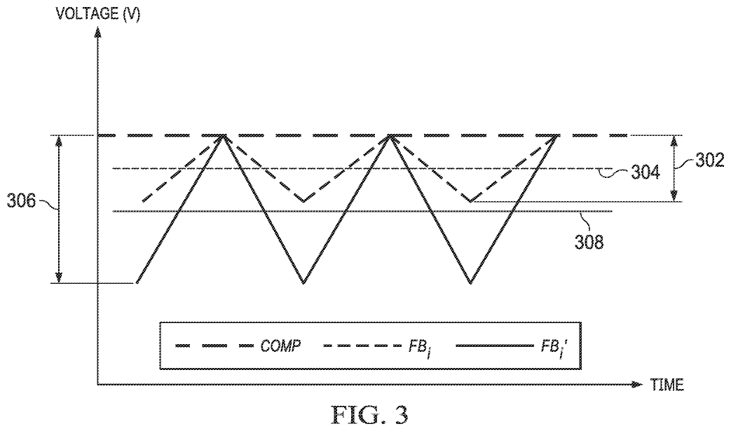

In some examples, the circuit 100 is part of a system, as illustrated in FIG. 2. The system includes a voltage input terminal 202, a voltage output terminal 204, a first switching circuit 206, a second switching circuit 212, a first inductor 208, a second inductor 214, a first current sensor 210, a second current sensor 216, the circuit 100, and a second circuit 200. In brief, circuit 200 is a copy of circuit 100. More particularly, circuit 200 includes a compensation terminal 102, a current feedback terminal 104, a voltage feedback terminal 106, a reference voltage terminal 108, a first output terminal 110, a second output terminal 112, a modulator 114, an error amplifier 116, and average current balancing circuitry 118.

The first switching circuit 206 and the second switching circuit 212 are coupled to the voltage input terminal 202 and the voltage output terminal 204. The first inductor 208 is coupled to the first switching circuit 206. The second inductor 214 is coupled to the second switching circuit 212. The first current sensor 210 is coupled to the first inductor 208. The second current sensor 216 is coupled to the second inductor 214. The compensation terminal 102 of circuit 100 is coupled to the compensation terminal 102 of circuit 200. The current feedback terminal 104 of circuit 100 is coupled to the first current sensor 210. The current feedback terminal 104 of circuit 200 is coupled to the second current sensor 216. The voltage feedback terminal 106 of circuit 100 and the voltage feedback terminal 106 of circuit 200 are coupled to the voltage output terminal 204. Output terminal 110 of circuit 100 is coupled to a first control terminal 206d of the first switching circuit 206. Output terminal 112 of circuit 100 is coupled to a second control terminal 206e of the first switching circuit 206. Output terminal 110 of circuit 200 is coupled to a first control terminal 212d of the second switching circuit 212. Output terminal 112 of circuit 200 is coupled to a second control terminal 212e of the second switching circuit 212. In some examples, the voltage input terminal 202 is coupled to a voltage source 218 and the voltage output terminal 204 is coupled to a load 220.

Circuit 100 is configured to control the first switching circuit 206 to control a current through the first inductor 208. Similarly, circuit 200 is configured to control the second switching circuit 212 to control a current through the second inductor 214. A challenge with the system is that in some cases, the inductance of the first inductor 208 may differ from the inductance of the second inductor 214. As a result, the average current through the first inductor 208 may differ from the average current through the second inductor 214. Consequently, power may be unevenly distributed between circuit 100 and circuit 200.

In various examples of the present disclosure, circuit 100 and circuit 200 each include average current balancing circuitry 118 for balancing the average current through the inductors 208, 214. A first input 118a of the average current balancing circuitry 118 is coupled to the output 116c of the error amplifier 116 and the compensation terminal 102. A second input 118b of the average current balancing circuitry 118 is coupled to the current feedback terminal 104. An output 118c of the average current balancing circuitry 118 is coupled to a second input 114b of the modulator 114. The average current balancing circuitry 118 and the error amplifier 116 are coupled in a second feedback path 122 which includes the voltage feedback terminal 106, the first input 116a of the error amplifier 116, the output 116c of the error amplifier 116, the compensation terminal 102, the first input 118a of the average current balancing circuitry 118, the output 118c of the average current balancing circuitry 118, and the second input 114b of the modulator 114. The average current balancing circuitry 118 is further coupled in a third feedback path 124 which includes the current feedback terminal 104, the second input 118b of the average current balancing circuitry 118, the output 118c of the average current balancing circuitry 118, and the second input 114b of the modulator 114.

The average current balancing circuitry 118 is configured to receive the compensation signal COMP from the compensation terminal 102, receive the current feedback signal FB; from the current feedback terminal 104, adjust the compensation signal COMP based on the current feedback signal FBᵢ, and output the adjusted compensation signal AC at the output 118c. The modulator 114 is configured to receive the adjusted compensation signal AC and output a modulated signals MOD₁, MOD₂ at the outputs 114c, 114d, respectively, based on the current feedback signal FBᵢ and the adjusted compensation signal AC.

The average current balancing circuitry 118 can adjust the compensation signal COMP, which causes the current through inductors 208, 214 to be adjusted, so that even when the inductances of the inductors 208, 214 differ, the average current through the inductors 208, 214 is approximately equal. Thus, power can be more evenly distributed between circuit 100 and circuit 200.

In the system illustrated in FIG. 2, the modulator 114 of circuit 100 is configured to receive a first current feedback signal FBᵢ indicating a current through the first inductor 208 from the first current sensor 210. The modulator 114 of circuit 200 is configured to receive a second current feedback signal FBᵢ′ indicating a current through the second inductor 214 from the second current sensor 216. The error amplifier 116 of circuit 100 and circuit 200 are configured to receive a voltage feedback signal FBᵥ indicating a voltage at the voltage output terminal 204. The error amplifier 116 of circuit 100 and circuit 200 are configured to receive a reference signal REF indicating a reference voltage from respective reference voltage terminals 108. The reference signal REF of circuit 100 is approximately equal to the reference signal REF of circuit 200. The error amplifiers 116 of circuit 100 and circuit 200 are configured to output a compensation signal COMP at the compensation terminals 102 of circuit 100 and circuit 200, which are coupled together.

The average current balancing circuitry 118 of circuit 100 and circuit 200 are configured to receive the compensation signal COMP from respective compensation terminals 102. The average current balancing circuitry 118 of circuit 100 is configured to receive the first current feedback signal FBᵢ from the first current sensor 210, adjust the compensation signal COMP based on the first current feedback signal FBᵢ, and output a first adjusted compensation signal AC to the modulator 114 of circuit 100, as further explained below. The modulator 114 of circuit 100 is configured to receive the first adjusted compensation signal AC and output first modulated signals MOD₁, MOD₂ based on the first current feedback signal FBᵢ and the first adjusted compensation signal AC. Similarly, the average current balancing circuitry 118 of circuit 200 is configured to receive the second current feedback signal FB/from the second current sensor 216, adjust the compensation signal COMP based on the second current feedback signal FBᵢ′, and output a second adjusted compensation signal AC′ to the modulator 114 of circuit 200. The modulator 114 of circuit 200 is configured to receive the second adjusted compensation signal AC′ and output second modulated signals MOD₁′, MOD₂′ based on the second current feedback signal FB/′ and the second adjusted compensation signal AC′. Switching circuit 206 is configured to perform switching in response to modulated signals MOD₁, MOD₂, thus controlling the current through inductor 208. Switching circuit 212 is configured to perform switching in response to modulated signals MOD₁′. MOD₂′, thus controlling the current through inductor 214.

In some examples (e.g., as illustrated in FIG. 2), the system forms a multi-phase boost converter which generates a voltage at the voltage output terminal 204 that is greater than a voltage at the voltage input terminal 202. In such examples, a first terminal 206a of the first switching circuit 206 is coupled to the voltage output terminal 204. A second terminal 206b of the first switching circuit 206 is coupled to a first terminal 208a of the first inductor 208. A third terminal 206c of the first switching circuit 206 is coupled to ground 222. A first control terminal 206d of the first switching circuit 206 is coupled to the first output terminal 110 of circuit 100. A second control terminal 206e of the first switching circuit 206 is coupled to the second output terminal 112 of circuit 100. A second terminal 208b of the first inductor 208 is coupled to the voltage input terminal 202.

Similarly, in such examples, a first terminal 212a of the second switching circuit 212 is coupled to the voltage output terminal 204. A second terminal 212b of the second switching circuit 212 is coupled to a first terminal 214a of the second inductor 214. A third terminal 212c of the second switching circuit 212 is coupled to ground 222. A first control terminal 212d of the second switching circuit 212 is coupled to the first output terminal 110 of circuit 200. A second control terminal 212e of the second switching circuit 212 is coupled to the second output terminal 112 of circuit 200. A second terminal 214b of the second inductor 214 is coupled to the voltage input terminal 202.

In some examples, the switching circuit 206 includes a first transistor (not labeled) and a second transistor (not labeled). The first transistor has a first terminal coupled to terminal 206a, a second terminal coupled to terminal 206b, and a control terminal coupled to control terminal 206d. The second transistor has a first terminal coupled to terminal 206b, a second terminal coupled to terminal 206c, and a control terminal coupled to control terminal 206e. Switching circuit 212 includes similar components with similar couplings, as shown in FIG. 2.

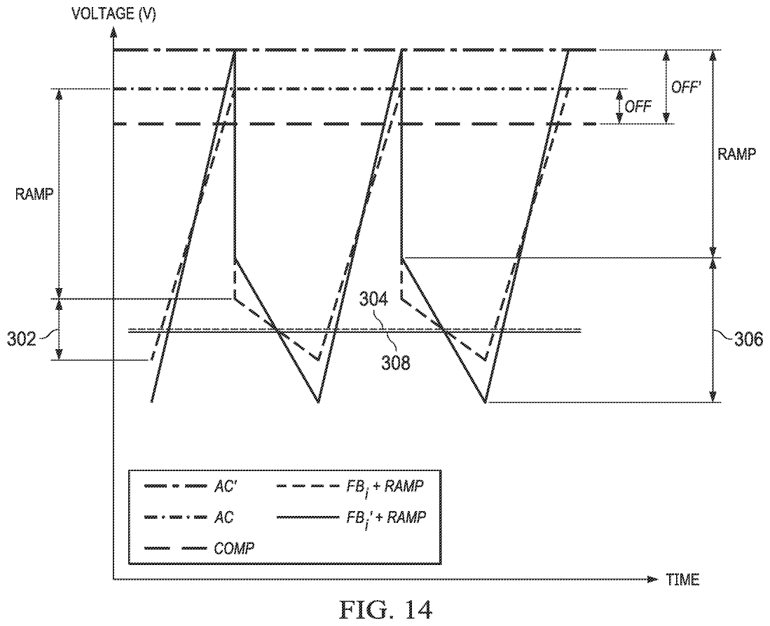

Although FIG. 2 illustrates a boost converter, it will be appreciated that in some examples, the system may alternatively be configured as a buck converter (e.g., as illustrated in FIG. 14A and FIG. 14B), a buck-boost converter, or the like. Further, although FIG. 2 illustrates a two device (e.g., two-phase) system, it will be appreciated that in some examples, the system may alternatively have some other number of devices (e.g., three devices, four devices, five devices, etc.), as indicated by ellipses 228. Furthermore, although FIG. 2 illustrates the switching circuits 206, 212 as being external to circuits 100, 200, respectively, (e.g., switching circuits 206, 212 are off-chip) it will be appreciated that in some examples, switching circuits 206, 212 may alternatively be included in circuits 100, 200, respectively, as illustrated by dashed lines 224, 226.

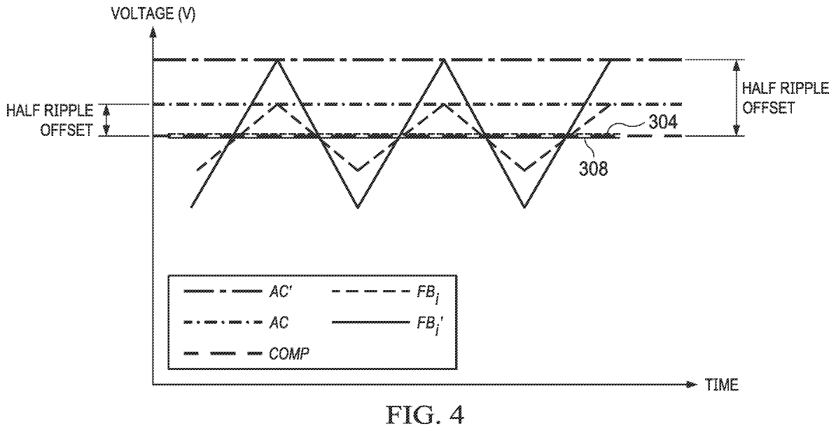

FIG. 3 and FIG. 4 are diagrams of some examples of signals corresponding to the system of FIG. 2.

The first current feedback signal FBᵢ (indicating the current through the first inductor 208) and the second current feedback signal FBᵢ′ (indicating the current through the second inductor 214) cycle between increasing and decreasing based on the switching of the first switching circuit 206 and the second switching circuit 212, respectively. Thus, the first current feedback signal FBᵢ has a first ripple 302 about a first average 304 and the second current feedback signal FBᵢ′ has a second ripple 306 about a second average 308. In some examples, current feedback signals FBᵢ, FBᵢ′ are voltage domain signals. In some examples, circuit 100 controls switching circuit 206 so that in response to the first current feedback signal FBᵢ reaching the compensation signal COMP (indicating a voltage at compensation terminal 102), the current through the first inductor 208 switches from increasing to decreasing. Similarly, circuit 200 controls switching circuit 212 so that in response to the second current feedback signal FBᵢ′ reaching the compensation signal COMP, the current through the second inductor 214 switches from increasing to decreasing. As a result, the peak of the first current feedback signal FBᵢ and the peak of the second current feedback signal FBᵢ′ are aligned with the compensation signal COMP. This may be referred to as “peak current control”. When the inductance of the first inductor 208 and the inductance of the second inductor 214 differ, the valley of the first current feedback signal FBᵢ and the valley of the second current feedback signal FBᵢ′ may differ and thus the average 304 of the first current feedback signal FBᵢ and the average 308 of the second current feedback signal FBᵢ′ may differ, as shown in FIG. 3. Thus, the power distribution between circuit 100 and circuit 200 may be unbalanced.

The average current balancing circuitry 118 can adjust the compensation signal COMP to align the averages 304, 308 of the current feedback signals FBᵢ, FBᵢ′. The compensation signal COMP is adjusted individually at circuit 100 and circuit 200 according to the first current feedback signal FBᵢ and the second current feedback signal FBᵢ′, respectively. By adjusting the compensation signal COMP individually at each of the circuits 100, 200, the peaks of the current feedback signals FBᵢ. FBᵢ′ shift so that the averages 304, 308 of the current feedback signals FBᵢ. FBᵢ′ algin. By adjusting the compensation signal COMP (via the average current balancing circuitry 118 of circuit 100) by half of the ripple 302 of the first current feedback signal FBᵢ, and by adjusting the compensation signal COMP (via the average current balancing circuitry 118 of circuit 200) by half of the ripple 306 of the second current feedback signal FBᵢ′, the averages 304, 308 of the current feedback signals FBᵢ, FBᵢ′ can be aligned, as shown in FIG. 4. Thus, power can be more evenly distributed between circuit 100 and circuit 200.

Alternatively, for “valley current control” (not shown), circuit 100 controls switching circuit 206 so that in response to the first current feedback signal FBᵢ dropping to the compensation signal COMP, the current through the first inductor 208 switches from decreasing to increasing. Similarly, circuit 200 controls switching circuit 212 so that in response to the second current feedback signal FBᵢ′ dropping to the compensation signal COMP, the current through the second inductor 214 switches from decreasing to increasing. As a result, the valley of the first current feedback signal FBᵢ and the valley of the second current feedback signal FBᵢ′ are aligned with the compensation signal COMP. In valley current control, the averages 304, 308 of the current feedback signals FBᵢ, FBᵢ′ can still be aligned by adjusting the compensation signal COMP (via the average current balancing circuitry 118 of circuit 100) by half of the ripple 302 of the first current feedback signal FBᵢ and by adjusting the compensation signal COMP (via the average current balancing circuitry 118 of circuit 200) by half of the ripple 306 of the second current feedback signal FBᵢ′.

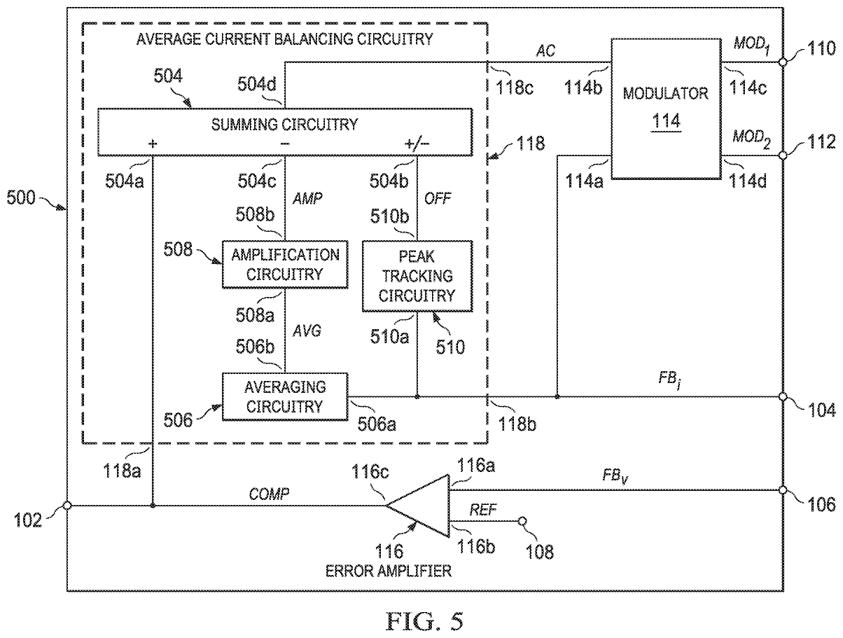

FIG. 5 is a circuit diagram of some examples of a circuit 500 similar to the circuit 100 of FIG. 1 in which the average current balancing circuitry 118 includes summing circuitry 504, averaging circuitry 506, amplification circuitry 508, and peak tracking circuitry 510.

An input 506a of the averaging circuitry 506 is coupled to the current feedback terminal 104. An input 508a of the amplification circuitry 508 is coupled to an output 506b of the averaging circuitry 506. An input 510a of the peak tracking circuitry 510 is coupled to the current feedback terminal 104. A first input 504a of the summing circuitry 504 is coupled to the output 116c of the error amplifier 116 and the compensation terminal 102. A second input 504b of the summing circuitry 504 is coupled to an output 510b of the peak tracking circuitry 510. A third input 504c of the summing circuitry 504 is coupled to an output 508b of the amplification circuitry 508. An output 504d of the summing circuitry 504 is coupled to the second input 114b of the modulator 114.

The averaging circuitry 506 is configured to receive the current feedback signal FBᵢ, determine an average of the current feedback signal FBᵢ, and output an averaged current feedback signal AVG based on the average of the current feedback signal FBᵢ. The amplification circuitry 508 is configured to receive the averaged current feedback signal AVG, amplify the averaged current feedback signal AVG, and output an amplified averaged current feedback signal AMP based on the averaged current feedback signal AVG and a gain of the amplification circuitry 508. The peak tracking circuitry 510 is configured to receive the current feedback signal FBᵢ, determine a peak of a ripple of the current feedback signal FBᵢ, and output an offset signal OFF based on the based on the peak of the ripple of the current feedback signal FBᵢ.

The summing circuitry 504 is configured to receive the compensation signal COMP, receive the offset signal OFF from the peak tracking circuitry 510, receive the amplified averaged current feedback signal AMP from the amplification circuitry 508, and output the adjusted compensation signal AC to the second input 114b of modulator 114 based on the amplified averaged current feedback signal AMP, the compensation signal COMP, and the offset signal OFF. When circuit 500 is using “peak current control”, the summing circuitry 504 is configured to output the adjusted compensation signal AC based on subtracting the amplified averaged current feedback signal AMP from the compensation signal COMP and adding the offset signal OFF to the compensation signal COMP. When circuit 500 is using “valley current control”, the summing circuitry 504 is configured to output the adjusted compensation signal AC based on subtracting the amplified averaged current feedback signal AMP and the offset signal OFF from the compensation signal COMP.

By adjusting (e.g., adding in peak current control, or subtracting in valley current control) the compensation signal COMP by the offset signal OFF, the offset between the averages of the current feedback signals (e.g., FBᵢ, FBᵢ′) due to a mismatch in the inductors (e.g., 208, 214) can be reduced or eliminated. Further, by subtracting the amplified averaged current feedback signal AMP from the compensation signal COMP, a negative feedback loop is formed. Thus, additional offset between the averages of the current feedback signals (e.g., FBᵢ, FBᵢ′) due to slight mismatches between like components (e.g., modulators 114) of different circuits (e.g., circuits 100, 200) of the system can be reduced proportional to the gain factor of the amplification circuitry 508.

In some examples, the offset signal OFF is half of the ripple of the current feedback signal FBᵢ, as shown in FIG. 4. In some other examples, the offset signal OFF is the peak of the current feedback signal FBᵢ. For example, because AC=COMP+OFF−M*AVG, where M is the gain factor of the amplification circuitry 508 and where OFF=0.5*RIPPLE, and because PEAK=0.5*RIPPLE+AVG, it is possible to substitute so that AC=COMP+ (PEAK−AVG)−M*AVG, which can be rearranged as AC=COMP+PEAK−(M+1)*AVG. Thus, the peak of the current feedback signal FBᵢ can be used instead of half of the ripple of the current feedback signal FBᵢ in some examples by adding 1 to the gain factor of the amplification circuitry 508.

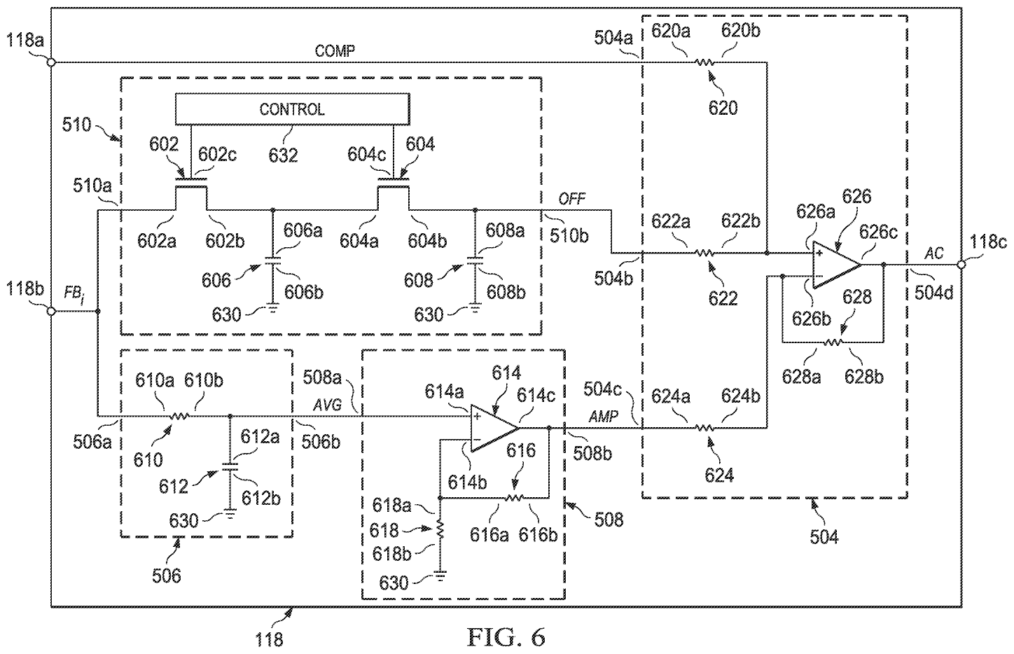

FIG. 6 is a circuit diagram of some examples of the average current balancing circuitry 118 of circuit 500 of FIG. 5 in which the average current balancing circuitry 118 operates in the voltage domain and in peak current control mode.

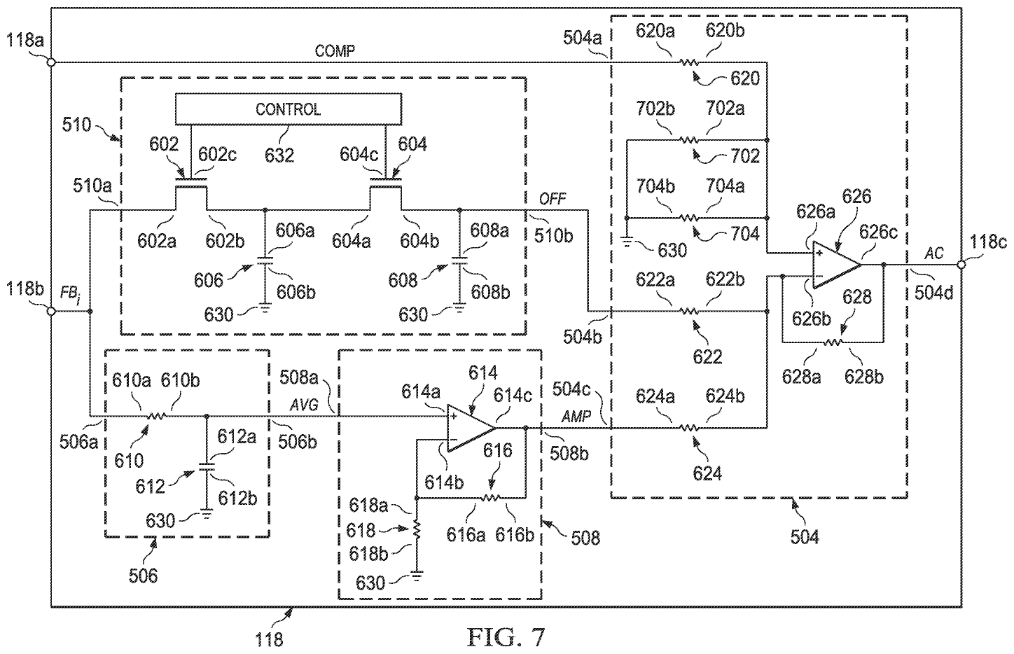

FIG. 7 is a circuit diagram of some examples of the average current balancing circuitry 118 of circuit 500 of FIG. 5 in which the average current balancing circuitry 118 operates in the voltage domain and in valley current control mode.

The averaging circuitry 506 includes a low pass filter. For example, referring to FIGS. 6 and 7, the averaging circuitry 506 includes resistor 610 and a capacitor 612. A first terminal 610a of resistor 610 is coupled to the second input 118b of the average current balancing circuitry 118. A second terminal 610b of resistor 610 is coupled to a first terminal 612a of capacitor 612. A second terminal 612b of capacitor 612 is coupled to ground 630.

Still referring to FIGS. 6 and 7, the amplification circuitry 508 includes an amplifier. For example, the amplification circuitry 508 includes an operation amplifier 614 and resistors 616, 618. A first input 614a of operation amplifier 614 is coupled to the second terminal 610b of resistor 610 and the first terminal 612a of capacitor 612. A second input 614b of operation amplifier 614 is coupled to a first terminal 616a of resistor 616 and a first terminal 618a of resistor 618. An output 614c of operational amplifier 614 is coupled to a second terminal 616b of resistor 616. A second terminal 618b of resistor 618 is coupled to ground 630.

Referring to FIGS. 6 and 7, the peak tracking circuitry 510 includes transistors 602, 604, and capacitors 606, 608. A first terminal 602a of transistor 602 is coupled to the second input 118b of the average current balancing circuitry 118. A second terminal 602b of transistor 602 is coupled to a first terminal 604a of transistor 604 and a first terminal 606a of capacitor 606. A second terminal 604b of transistor 604 is coupled to a first terminal of capacitor 608. A second terminal 606b of capacitor 606 and a second terminal 608b of capacitor 608 are coupled to ground 630. A control terminal 602c of transistor 602 and a control terminal 604c of transistor 604 are coupled to control circuitry 632.

Referring to FIG. 6, the summing circuitry 504 is an amplifier with summing a component and a differential component. In some examples (FIG. 6), the summing circuitry 504 includes resistors 620, 622, 624, 628, and operational amplifier 626. A first terminal 620a of resistor 620 is coupled to the first input 118a of the average current balancing circuitry 118. A first terminal 622a of resistor 622 is coupled to the second terminal 604b of transistor 604 and the first terminal 608a of capacitor 608. A first terminal 624a of resistor 624 is coupled to the output 614c of operational amplifier 614 and the second terminal 616b of resistor 616. A second terminal 620b of resistor 620 and a second terminal 622b of resistor 622 are coupled to a first input 626a of operational amplifier 626. A second terminal 624b of resistor 624 and a first terminal 628a of resistor 628 are coupled to a second input 626b of operational amplifier 626. A second terminal 628b of resistor 628 is coupled to an output 626c of operational amplifier 626 and the output 118c of the average current balancing circuitry 118.

In some other examples (FIG. 7), the second terminal 622b of resistor 622 is coupled to the second input 626b of operational amplifier 626. Further, resistors 702, 704 are coupled in parallel between the first input 626a of operational amplifier 626 and ground 630. More particularly, a first terminal 702a of resistor 702 and a first terminal 704a of resistor 704 are coupled to the first input 626a of operational amplifier 626. A second terminal 702b of resistor 702 and a second terminal 704b of resistor 704 are coupled to ground 630.

Referring to FIGS. 6 and 7, the low pass filter of the averaging circuitry 506 is configured to filter out high frequency components from the ripple of the current feedback signal FBᵢ (indicating the inductor current) so that the average of the current feedback signal FBᵢ (the averaged current feedback signal AVG) remains. The amplifier of the amplification circuitry 508 is configured to amplify the averaged current feedback signal AVG by a gain factor.

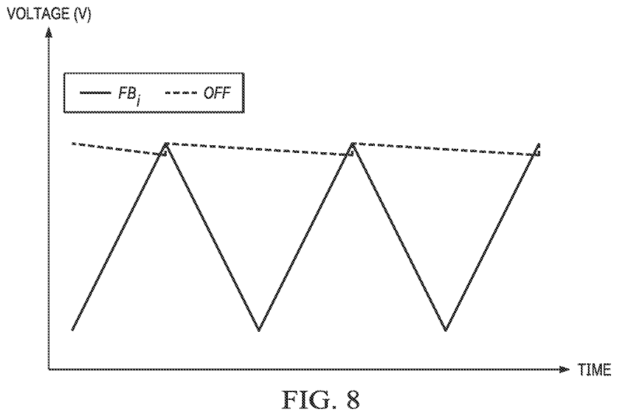

The control circuitry 632 of the peak tracking circuitry 510 in FIGS. 6 and 7 is configured to control the first transistor 602 and the second transistor 604 so that the first transistor 602 is ON and the second transistor is OFF when the current feedback signal FBᵢ is increasing to charge the first capacitor 606 according to the current feedback signal FBᵢ. Then, the control circuitry 632 of the peak tracking circuitry 510 is configured to control the first transistor 602 and the second transistor 604 so that the first transistor 602 is OFF and the second transistor 604 is ON when the current feedback signal FBᵢ is decreasing to transfer the charge from the first capacitor 606 to the second capacitor 608 and to provide an output voltage (e.g., the offset signal OFF) that is proportional to the current feedback signal FBᵢ at the output 510b. Then, the control circuitry 632 of the peak tracking circuitry 510 is configured to control the first transistor 602 and the second transistor 604 so that the first transistor 602 is ON and the second transistor 604 is OFF when the current feedback signal FBᵢ is increasing again to charge the first capacitor 606 again according to the current feedback signal FBᵢ while isolating the second capacitor 608 from the current feedback signal FBᵢ so that the output voltage (e.g., the offset signal OFF) remains approximately unchanged. Example plots of the current feedback signal FBᵢ and the offset signal OFF are illustrated in FIG. 8.

In some examples (FIG. 6), the amplifier of the summing circuitry 504 outputs a voltage that is proportional to the voltage at input 504a plus the voltage at input 504b minus the voltage at the input 504c. In some examples (FIG. 7), the amplifier of the summing circuitry 504 outputs a voltage that is proportional to the voltage at input 504a minus the voltage at input 504b minus the voltage at the input 504c.

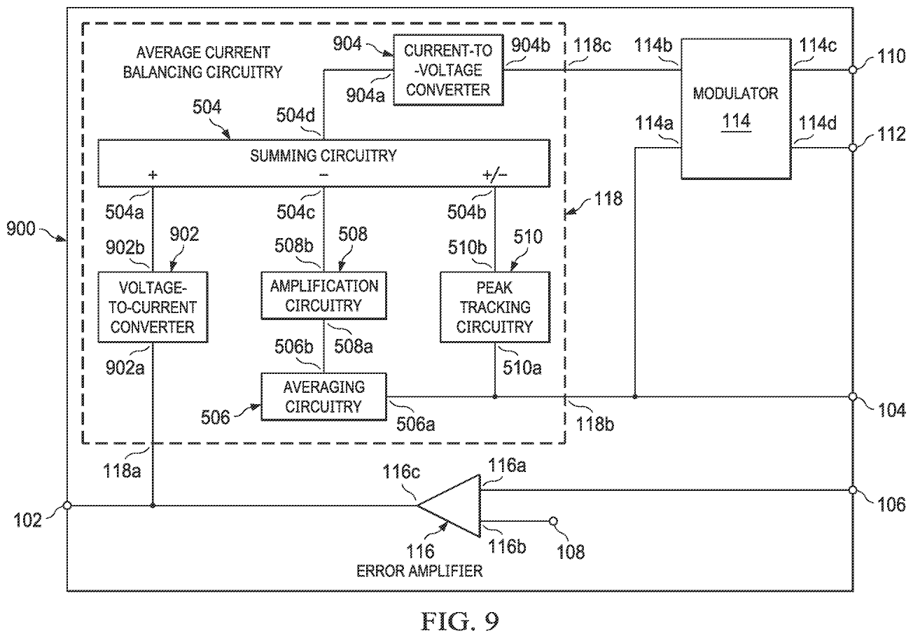

FIG. 9 is a circuit diagram of some examples of a circuit 900 similar to the circuit 500 of FIG. 5 in which the average current balancing circuitry 118 includes a voltage-to-current converter 902 and a current-to-voltage converter 904 so that the average current balancing circuitry 118 can operate in the current domain.

The voltage-to-current converter 902 has an input coupled to the compensation terminal 102 and the output 116c of the error amplifier 116. The voltage-to-current converter 902 has an output coupled to the first input 504a of the summing circuitry 504. The voltage-to-current converter 902 is configured to convert the compensation signal COMP from the voltage domain to the current domain.

The current-to-voltage converter 904 has an input coupled to the output 504d of the summing circuitry 504. The current-to-voltage converter 904 has an output coupled to the second input 114b of the modulator 114. The current-to-voltage converter 904 is configured to convert the adjusted compensation signal AC from the current domain to the voltage domain.

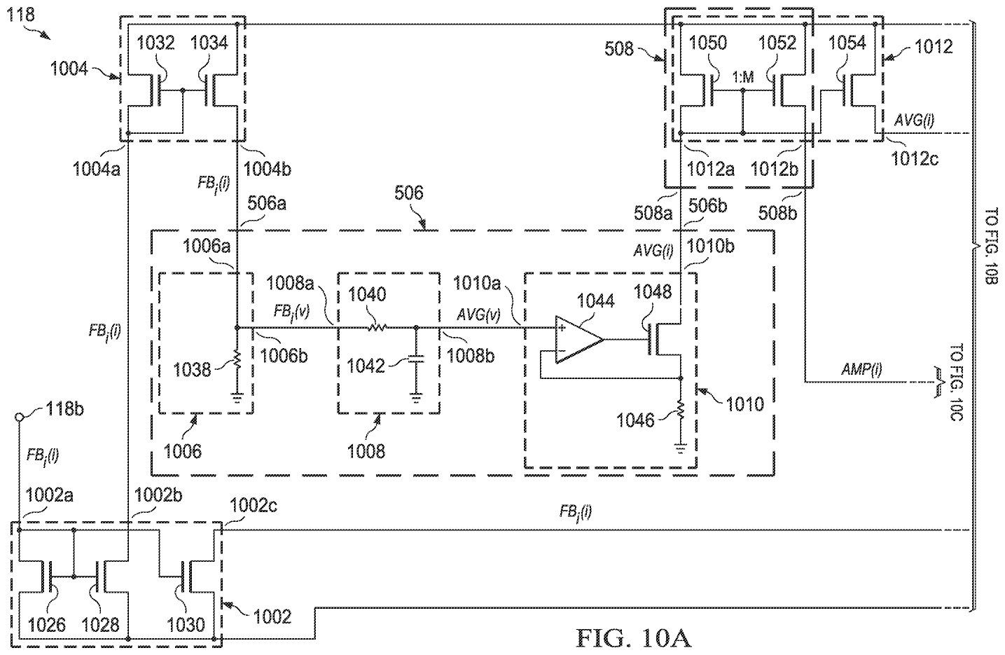

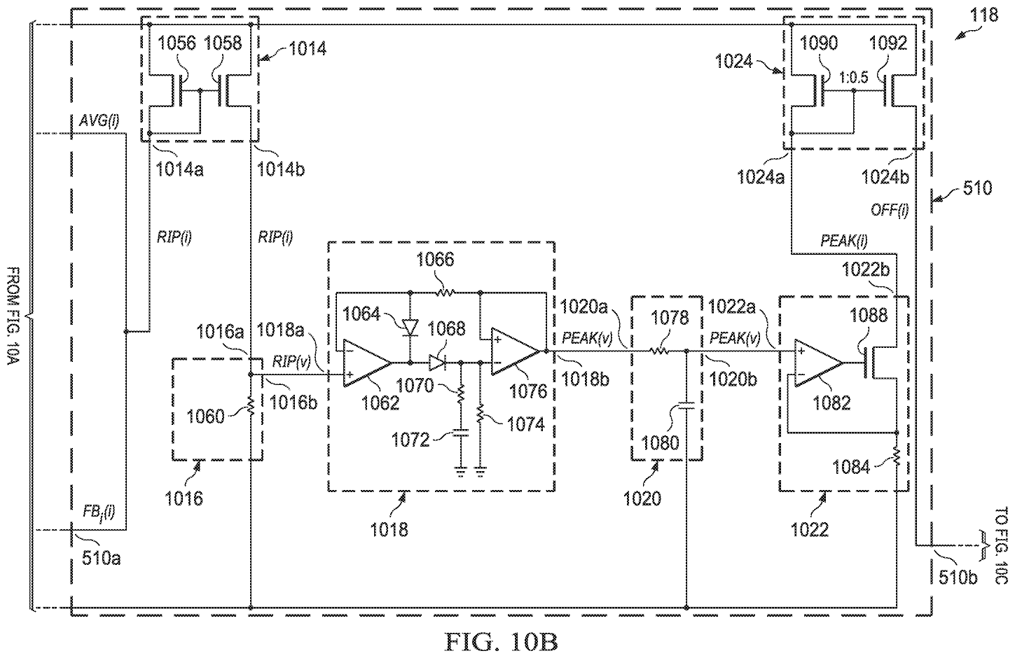

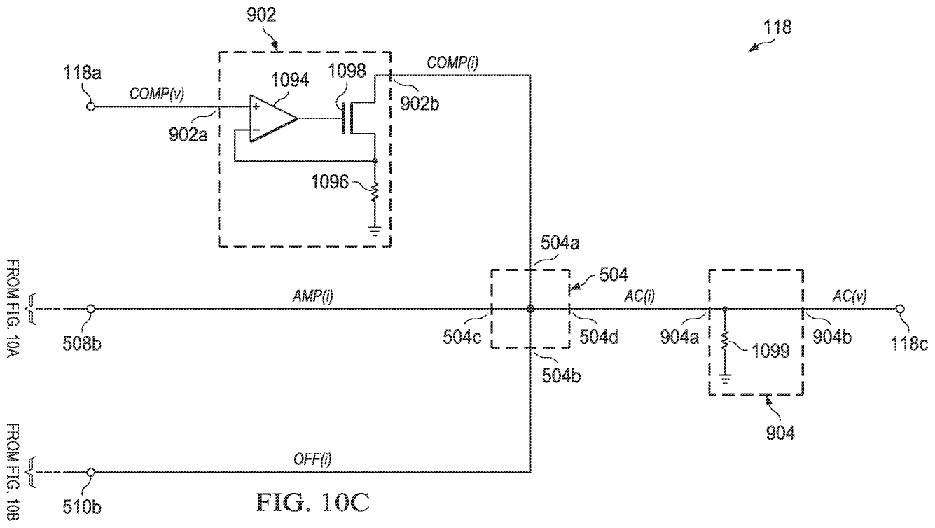

FIG. 10A, FIG. 10B, and FIG. 10C are circuit diagrams of some examples of the average current balancing circuitry 118 of circuit 900 of FIG. 9 in which the average current balancing circuitry 118 operates in the current domain.

The average current balancing circuitry 118 includes a first current mirror 1002 and a second current mirror 1004. An input 1002a of the first current mirror 1002 is coupled to the second input 118b of the average current balancing circuitry 118. A first output 1002b of the first current mirror 1002 is coupled to an input 1004a of the second current mirror 1004. A second output 1002c of the first current mirror 1002 is coupled to the input 510a of the peak tracking circuitry 510. An output 1004b of the second current mirror 1004 is coupled to the input 506a of the averaging circuitry 506.

In some examples, the first current mirror 1002 includes a first transistor 1026, a second transistor 1028, and a third transistor 1030. A first terminal of the first transistor 1026 is coupled to the input 1002a of the first current mirror 1002. A control terminal of the first transistor 1026, a control terminal of the second transistor 1028, and a control terminal of the third transistor 1030 are coupled to the first terminal of the first transistor 1026. A second terminal of the first transistor 1026 is coupled to a first terminal of the second transistor 1028 and a first terminal of the third transistor 1030. A second terminal of the second transistor 1028 is coupled to the first output 1002b of the first current mirror 1002. A second terminal of the third transistor 1030 is coupled to the second output 1002c of the first current mirror 1002.

In some examples, the second current mirror 1004 includes a first transistor 1032 and a second transistor 1034. A first terminal of the first transistor 1032 is coupled to the input 1004a of the second current mirror 1004. A control terminal of the first transistor 1032 and a control terminal of the second transistor 1034 are coupled to the first terminal of the first transistor 1032. A second terminal of the first transistor 1032 is coupled to a first terminal of the second transistor 1034. A second terminal of the second transistor 1034 is coupled to the output 1004b of the second current mirror 1004.

The averaging circuitry 506 includes a current-to-voltage converter 1006, a low pass filter 1008, and a voltage-to-current converter 1010. An input 1006a of current-to-voltage converter 1006 is coupled to the input 506a of the averaging circuitry 506. An output 1006b of current-to-voltage converter 1006 is coupled to an input 1008a of low pass filter 1008. An output 1008b of low pass filter 1008 is coupled to an input 1010a of voltage-to-current converter 1010. An output 1010b of voltage-to-current converter 1010 is coupled to the output 506b of the averaging circuitry 506.

In some examples, current-to-voltage converter 1006 includes a resistor 1038. A first terminal of the resistor 1038 is coupled to input 1006a and output 1006b. A second terminal of the resistor 1038 is coupled to ground.

In some examples, low pass filter 1008 includes a resistor 1040 and a capacitor 1042. A first terminal of the resistor 1040 is coupled to input 1008a. A second terminal of the resistor 1040 is coupled to a first terminal of the capacitor 1042 and output 1008b. A second terminal of the capacitor 1042 is coupled to ground.

In some examples, voltage-to-current converter 1010 includes an operational amplifier 1044, a resistor 1046, and a transistor 1048. A first input of the operation amplifier 1044 is coupled to input 1010a. A second input of the operational amplifier 1044 is coupled to a first terminal of the resistor 1046 and a first terminal of the transistor 1048. An output of the operational amplifier 1044 is coupled to a control terminal of the transistor 1048. A second terminal of the resistor 1046 is coupled to ground. A second terminal of the transistor 1048 is coupled to output 1010b.

The average current balancing circuitry 118 includes a third current mirror 1012. The amplification circuitry 508 includes a portion of the third current mirror 1012. An input 1012a of the third current mirror 1012 is coupled to the input 508a of the amplification circuitry 508. A first output 1012b of the third current mirror 1012 is coupled to the output 508b of the amplification circuitry 508.

In some examples, the third current mirror 1012 includes a first transistor 1050, a second transistor 1052, and a third transistor 1054. A first terminal of the first transistor 1050 is coupled to input 1012a. A control terminal of the first transistor 1050, a control terminal of the second transistor 1052, and a control terminal of the third transistor 1054 are coupled to the first terminal of the first transistor 1050. A second terminal of the first transistor 1050 is coupled to a first terminal of the second transistor 1052 and a first terminal of the third transistor 1054. A second terminal of the second transistor 1052 is coupled to first output 1012b. A second terminal of the third transistor 1054 is coupled to second output 1012c.

The peak tracking circuitry 510 includes a fourth current mirror 1014, a current-to-voltage converter 1016, a peak tracker 1018, a low pass filter 1020, a voltage-to-current converter 1022, and a fifth current mirror 1024. The input 510a of the peak tracking circuitry 510 and a second output 1012c of the third current mirror 1012 are coupled to an input 1014a of the fourth current mirror 1014. An output 1014b of the fourth current mirror 1014 is coupled to an input 1016a of current-to-voltage converter 1016. And output 1016b of current-to-voltage converter 1016 is coupled to an input 1018a of the peak tracker 1018. An output 1018b of the peak tracker 1018 is coupled to an input 1020a of low pass filter 1020. An output 1020b of low pass filter 1020 is coupled to an input 1022a of voltage-to-current converter 1022. An output 1022b of voltage-to-current converter 1022 is coupled to an input 1024a of the fifth current mirror 1024. An output 1024b of the fifth current mirror 1024 is coupled to the output 510b of the peak tracking circuitry 510.

In some examples, the fourth current mirror 1014 includes a first transistor 1056 and a second transistor 1058. A first terminal of the first transistor 1056 is coupled to input 1014a. A control terminal of the first transistor 1056 and a control terminal of the second transistor 1058 are coupled to the first terminal of the first transistor 1056. A second terminal of the first transistor 1056 is coupled to a first terminal of the second transistor 1058. A second terminal of the second transistor 1058 is coupled to output 1014b.

In some examples, current-to-voltage converter 1016 includes a resistor 1060. A first terminal of the resistor 1060 is coupled to input 1016a and output 1016b.

In some examples, peak tracker 1018 includes a first operational amplifier 1062, a second operational amplifier 1076, a first diode 1064, a second diode 1068, a first resistor 1066, a second resistor 1070, a third resistor 1074, and a capacitor 1072. A first input of the first operational amplifier 1062 is coupled to input 1018a. A second input of the first operational amplifier 1062 is coupled to a first terminal of the first diode 1064 and a first terminal of the first resistor 1066. An output of the first operational amplifier 1062 is coupled to a second terminal of the first diode 1064 and a first terminal of the second diode 1068. A second terminal of the second diode 1068 is coupled to a first terminal of the second resistor 1070, a first terminal of the third resistor 1074, and a first terminal of the second operational amplifier 1076. A second terminal of the second resistor 1070 is coupled to a first terminal of the capacitor 1072. A second terminal of the capacitor 1072 and a second terminal of the third resistor 1074 are coupled to ground. A second terminal of the first resistor 1066 is coupled to a second input of the second operational amplifier 1076, an output of the second operational amplifier 1076, and output 1018b.

In some examples, low pass filter 1020 includes a resistor 1078 and a capacitor 1080. A first terminal of the resistor 1078 is coupled to input 1020a. A second terminal of the resistor 1078 is coupled to a first terminal of the capacitor 1080 and output 1020b.

In some examples, voltage-to-current converter 1022 includes an operational amplifier 1082, a resistor 1084, and a transistor 1088. A first input of the operation amplifier 1082 is coupled to input 1022a. A second input of the operational amplifier 1082 is coupled to a first terminal of the resistor 1084 and a first terminal of the transistor 1088. An output of the operational amplifier 1082 is coupled to a control terminal of the transistor 1088. A second terminal of the transistor 1088 is coupled to output 1022b.

In some examples, the fifth current mirror 1024 includes a first transistor 1090 and a second transistor 1092. A first terminal of the first transistor 1090 is coupled to input 1024a. A control terminal of the first transistor 1090 and a control terminal of the second transistor 1092 are coupled to the first terminal of the first transistor 1090. A second terminal of the first transistor 1090 is coupled to a first terminal of the second transistor 1092. A second terminal of the second transistor 1092 is coupled to output 1012b.

In some examples, voltage-to-current converter 902 includes an operational amplifier 1094, a resistor 1096, and a transistor 1098. A first input of the operation amplifier 1094 is coupled to input 902a. A second input of the operational amplifier 1094 is coupled to a first terminal of the resistor 1096 and a first terminal of the transistor 1098. An output of the operational amplifier 1094 is coupled to a control terminal of the transistor 1098. A second terminal of the transistor 1098 is coupled to output 902b.

In some examples, summing circuitry 504 is a terminal where first input 504a, second input 504b, third input 504c, and output 504d are shorted together.

In some examples, current-to-voltage converter 904 includes a resistor 1099. A first terminal of the resistor 1099 is coupled to input 904a and output 904b. A second terminal of the resistor 1099 is coupled to ground.

In operation, the first current mirror 1002 receives the current feedback signal FBᵢ (in the current domain (i)) at input 1002a and outputs the current feedback signal FBᵢ (in the current domain (i)) at output 1002b and output 1002c. The second current mirror 1004 receives the current feedback signal FBᵢ (in the current domain (i)) at input 1004a and outputs the current feedback signal FBᵢ (in the current domain (i)) at output 1004b. Current-to-voltage converter 1006 receives the current feedback signal FBᵢ (in the current domain (i)) at input 1006a and outputs the current feedback signal FBᵢ (in the voltage domain (v)) at output 1006b. Low pass filter 1008 receives the current feedback signal FBᵢ (in the voltage domain (v)) at input 1008a and outputs the averaged current feedback signal AVG (in the voltage domain (v)) at output 1008b. Voltage-to-current converter 1010 receives the averaged current feedback signal AVG (in the voltage domain (v)) at input 1010a and outputs the averaged current feedback signal AVG (in the current domain (i)) at output 1010b. The third current mirror 1012 receives the averaged current feedback signal AVG (in the current domain (i)) at input 1012a, outputs the averaged current feedback signal AVG (in the current domain (i)) at output 1012c, and outputs the amplified averaged current feedback signal AMP (in the current domain (i)) at output 1012b according to a ratio 1:M of the transconductance of the transistors 1050, 1052, where M is the gain factor of the amplification circuitry 508. The fourth current mirror 1014 receives the sum of the current feedback signal FBᵢ (in the current domain (i)) from output 1002c and the averaged current feedback signal AVG (in the current domain (i)) from output 1012c at input 1014a. This sum is the ripple RIP of the current feedback signal FBᵢ centered about zero (e.g., the ripple minus the average of the ripple). The fourth current mirror 1014 outputs the ripple RIP (in the current domain (i)) at output 1014b. Current-to-voltage converter 1016 receives the ripple RIP (in the current domain (i)) at input 1016a and outputs the ripple RIP (in the voltage domain (v)) at output 1016b. The peak tracker 1018 receives the ripple RIP (in the voltage domain (v)) at input 1018a and outputs the peak PEAK (in the voltage domain (v)) of the ripple RIP at output 1018b. Low pass filter 1020 receives the peak PEAK (in the voltage domain (v)) at input 1020a and outputs a filtered peak PEAK (in the voltage domain (v)) at 1020b. Voltage-to-current converter 1022 receives the filtered peak PEAK (in the voltage domain (v)) at input 1022a and outputs the filtered peak PEAK (in the current domain (i)) at output 1022b. The fifth current mirror 1024 receives the filtered peak PEAK (in the current domain (i)) at input 1024a and outputs the offset signal OFF (in the current domain (i)) at output 1024b according to a ratio of 1:0.5 of the transconductance of the transistors 1090, 1092. The offset signal OFF (in the current domain (i)) is half of the peak of the ripple. The voltage-to-current converter 902 receives the compensation signal COMP (in the voltage domain (v)) at input 902a and outputs the compensation signal COMP (in the current domain (i)) at output 902b. The summing circuitry 504 receives the compensation signal COMP (in the current domain (i)), the amplified averaged current feedback signal AMP (in the current domain (i)), and the offset signal OFF (in the current domain (i)), and outputs the sum of these currents at output 504d. This sum is the adjusted compensation signal AC (in the current domain (i)). The current-to-voltage converter 904 receives the adjusted compensation signal AC (in the current domain (i)) at input 904a and outputs the adjusted compensation signal AC (in the voltage domain (v)) at output 904b. The example illustrated in FIGS. 10A, 10B, 10C is a peak current control example in the current domain. Valley current control can also be implemented by adjusting the circuitry to adjust the directions of the currents to adjust the summing (e.g., to adjust the signs of the summing inputs).

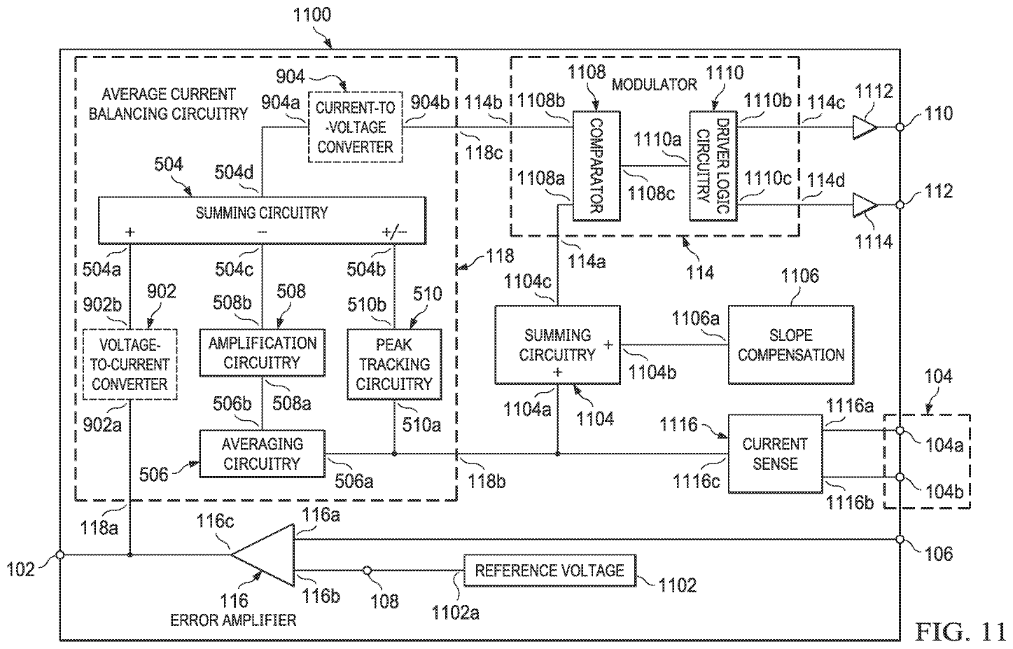

FIG. 11 is a circuit diagram of some examples of a circuit 1100 similar to the circuit 900 of FIG. 9 further including a current sense amplifier 1116, reference voltage generation circuitry 1102, summing circuitry 1104, slope compensation circuitry 1106, and gate drivers 1112, 1114.

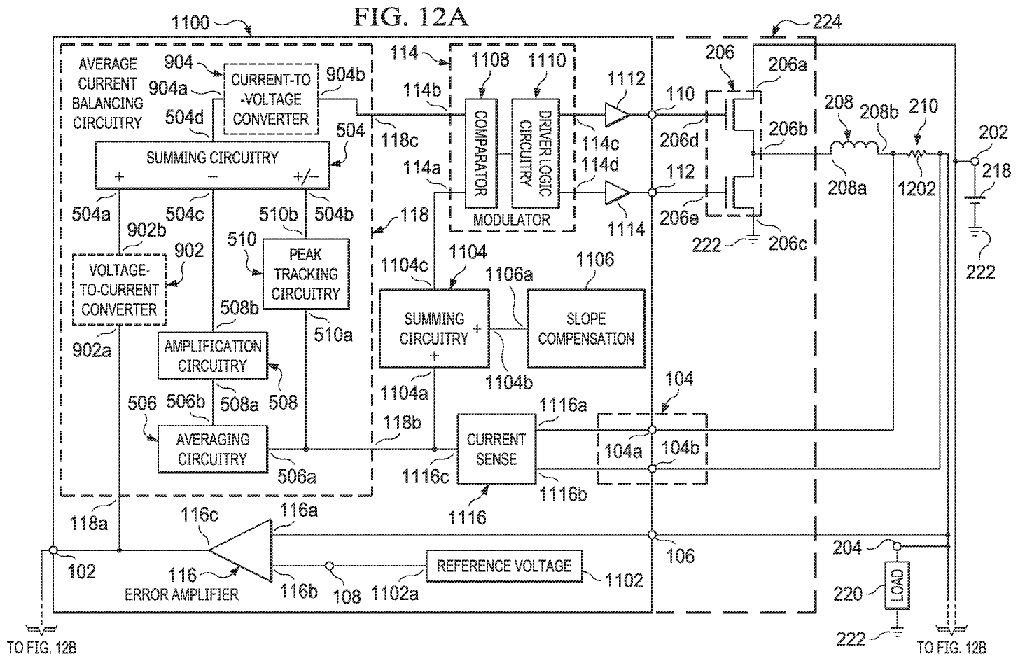

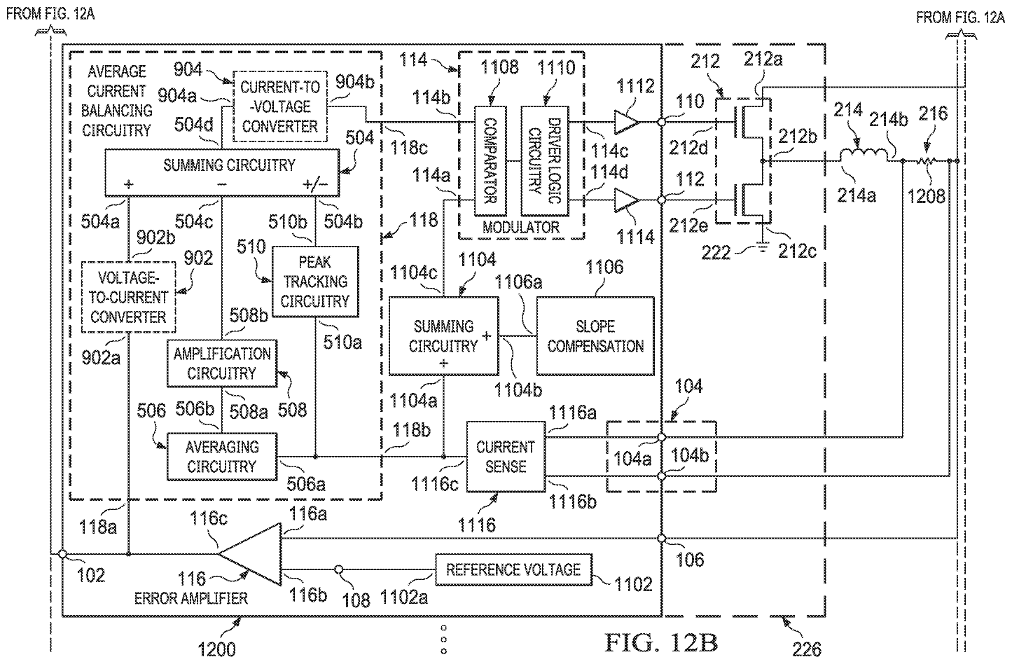

The current feedback terminal 104 includes a first subterminal 104a and a second subterminal 104b. A first input 1116a of the current sense amplifier 1116 is coupled to the first subterminal 104a of the current feedback terminal 104 and a second input 1116b of the current sense amplifier 1116 is coupled to the second subterminal 104b of the current feedback terminal 104. An output 1116c of the current sense amplifier 1116 is coupled to the first input 114a of the modulator 114, the input 506a of the averaging circuitry 506, and the input 510a of the peak tracking circuitry 510. The current sense amplifier 1116 is configured to receive a first voltage at input 1116a and a second voltage at input 1116b, where the difference between the first voltage and the second voltage indicates a voltage drop across a sense resistor (e.g., sense resistor 1202 of FIG. 12A). The current sense amplifier 1116 is configured to output the current feedback signal FBᵢ at output 1116c based on the first voltage, the second voltage, the resistance of the sense resistor, and a gain of the current sense amplifier 1116.

The reference voltage generation circuitry 1102 has an output 1102a coupled to input 116b of the error amplifier 116 (e.g., via reference voltage terminal 108). A first input 1104a of summing circuitry 1104 is coupled to the output 1116c of the current sense amplifier 1116. A second input 1104b of the summing circuitry 1104 is coupled to an output 1106a of the slope compensation circuitry 1106. An output 1104c of the summing circuitry 1104 is coupled to input 114a of modulator 114. The slope compensation circuitry 1106 is configured to generate a ramp signal at output 1106a. Summing circuitry 1104 is configured to add the ramp signal from output 1106a to the current feedback signal from output 1116c, and output the sum at output 1104c.

Gate driver 1112 is coupled between the first output 114c of the modulator 114 and the first output terminal 110. Gate driver 1114 is coupled between the second output 114d of the modulator 114 and the second output terminal 112. In some examples, the gate drivers 1112, 1114 include a plurality of transistors which have control terminals coupled to the modulator 114 and which are configured to drive the transistors of switching circuits (e.g., 206, 212 of FIG. 12A and FIG. 12B) coupled to output terminals 110, 112.

In some examples, the modulator 114 includes a comparator 1108 (e.g., a pulse width modulation (PWM) comparator or the like) and driver logic circuitry 1110 (e.g., a set-reset (SR) latch or the like). Comparator 1108 has a first input 1108a coupled to the first input 114a of the modulator 114, a second input 1108b coupled to the second input 114b of the modulator 114, and an output 1108c coupled to an input 1110a of driver logic circuitry 1110. The driver logic circuitry 1110 has a first output 1110b coupled to the first output 114c of the modulator 114 and second output 1110c coupled to the second output 114d of the modulator 114.

FIG. 12A and FIG. 12B are a circuit diagram of some examples of a system including the circuit 1100 of FIG. 11.

The first current sensor 210 and the second current sensor 216 include a first current sense resistor 1202 and a second current sense resistor 1208, respectively. A first terminal of the first sense resistor 1202 and a second terminal of the first sense resistor 1202 are coupled to first subterminal 104a and second subterminal 104b of circuit 1100, respectively. A first terminal of the second sense resistor 1208 and a second terminal of the second sense resistor 1208 are coupled to first subterminal 104a and second subterminal 104b of circuit 1200, respectively.

In some cases, a resistance of the first sense resistor 1202 may differ from a resistance of the second sense resistor 1208, which can cause the average current through the inductors 208, 214 to differ. However, because the adjusted compensation signal AC is generated, in part, by subtracting the amplified averaged current feedback signal AMP from the compensation signal COMP, the average current balancing circuitry 118 can suppress the mismatch between the sense resistors 1202, 1208. Thus, the average current through the inductors 208, 214 can be balanced even when sense resistors 1202, 1208 differ. In some examples, the greater the gain of the amplification circuitry 508, the less impact the mismatch in sense resistors may have on the balance of the average currents through the inductors 208, 214.

In some examples (e.g., as illustrated in FIG. 14A and FIG. 14B), the system forms a multi-phase buck converter which generates a voltage at the voltage output terminal 204 that is less than a voltage at the voltage input terminal 202. In such examples, a first terminal 206a of the first switching circuit 206 is coupled to the voltage input terminal 202, a second terminal 206b of the first switching circuit 206 is coupled to a first terminal 208a of the first inductor 208, and a second terminal 208b of the first inductor 208 is coupled to the voltage output terminal 204. Similarly, in such examples, a first terminal 212a of the second switching circuit 212 is coupled to the voltage input terminal 202, a second terminal 212b of the second switching circuit 212 is coupled to a first terminal 214a of the second inductor 214, and a second terminal 214b of the second inductor 214 is coupled to the voltage output terminal 204.

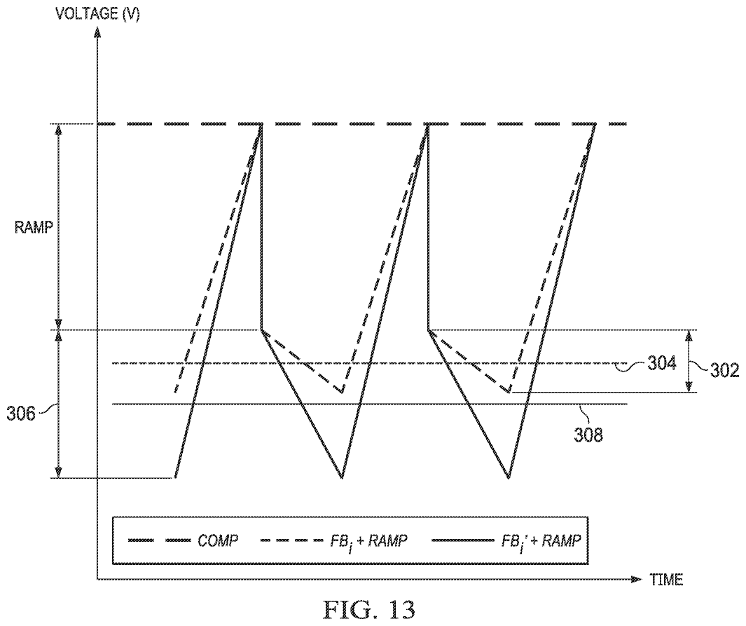

FIG. 13 and FIG. 14 are plots of some examples of the first current feedback signal FBᵢ, the second current feedback signal FB/′, and the compensation signal COMP corresponding to the system of FIG. 12A and FIG. 12B.

FIG. 13 is a plot of the signals without adjusting the compensation signal COMP. FIG. 14 is a plot of the signals when the compensation signal COMP is adjusted by half of the ripple of the current feedback signals FBᵢ, FBᵢ′. FIG. 14 shows that even when adding the ramp signal (from the slope compensation circuitry 1106) to the current feedback signals FBᵢ, FBᵢ′, adjusting the compensation signal COMP by half of the ripple of the current feedback signals FBᵢ, FBᵢ′ (e.g., adjusting the compensation signal COMP by offset signals OFF, OFF′) can still cause the averages of the current feedback signals FBᵢ, FBᵢ′ to align.

The methods are illustrated and described above as a series of acts or events, but the illustrated ordering of such acts or events is not limiting. For example, some acts or events may occur in different orders and/or concurrently with other acts or events apart from those illustrated and/or described herein. Also, some illustrated acts or events are optional to implement one or more aspects or embodiments of this description. Further, one or more of the acts or events depicted herein may be performed in one or more separate acts and/or phases. In some embodiments, the methods described above may be implemented in a computer readable medium using instructions stored in a memory.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors are described herein, other transistors (or equivalent devices) may be used instead with little or no change to the remaining circuitry. For example, a metal-oxide-silicon FET (“MOSFET”) (such as an n-channel MOSFET, nMOSFET, or a p-channel MOSFET, pMOSFET), a bipolar junction transistor (BJT—e.g. NPN or PNP), insulated gate bipolar transistors (IGBTs), and/or junction field effect transistor (JFET) may be used in place of or in conjunction with the devices disclosed herein. The transistors may be depletion mode devices, drain-extended devices, enhancement mode devices, natural transistors or other type of device structure transistors. Furthermore, the devices may be implemented in/over a silicon substrate (Si), a silicon carbide substrate (SiC), a gallium nitride substrate (GaN) or a gallium arsenide substrate (GaAs).

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. Unless otherwise stated, “about,” “approximately,” or “substantially” preceding a value means+/−10 percent of the stated value, or, if the value is zero, a reasonable range of values around zero.

Modifications are possible in the described examples, and other implementations are possible, within the scope of the claims.

What is claimed is:

1. A circuit comprising:
a compensation terminal, a current feedback terminal, a voltage feedback terminal, and a reference voltage terminal;
a modulator having a first input, a second input, a first output, and a second output, the first input of the modulator coupled to the current feedback terminal;
an error amplifier having a first input, a second input, and an output, the first input of the error amplifier coupled to the voltage feedback terminal, the second input of the error amplifier coupled to the reference voltage terminal, the output of the error amplifier coupled to the compensation terminal; and
average current balancing circuitry having a first input, a second input, and an output, the first input of the average current balancing circuitry coupled to the output of the error amplifier and the compensation terminal, the second input of the average current balancing circuitry coupled to the current feedback terminal, the output of the average current balancing circuitry coupled to the second input of the modulator.

2. The circuit of claim 1, the average current balancing circuitry comprising:
summing circuitry having a first input, a second input, and an output, the first input of the summing circuitry coupled to the output of the error amplifier and the compensation terminal, the output of the summing circuitry coupled to the second input of the modulator; and
peak tracking circuitry having an input and an output, the input of the peak tracking circuitry coupled to the current feedback terminal, the output of the peak tracking circuitry coupled to the second input of the summing circuitry.

3. The circuit of claim 2, the average current balancing circuitry further comprising:
averaging circuitry having an input and an output, the input of the averaging circuitry coupled to the current feedback terminal; and
amplification circuitry having an input and an output, the input of the amplification circuitry coupled to the output of the averaging circuitry, the output of the amplification circuitry coupled to a third input of the summing circuitry.

4. The circuit of claim 3, further comprising:
a current sense amplifier having an input and an output, the input of the current sense amplifier coupled to the current feedback terminal, the output of the current sense amplifier coupled to the first input of the modulator, the input of the averaging circuitry, and the input of the peak tracking circuitry.

5. The circuit of claim 4, wherein the summing circuitry is first summing circuitry, the circuit further comprising:
slope compensation circuitry having an output; and
second summing circuitry having a first input, a second input, and an output, the first input of the second summing circuitry coupled to the output of the current sense amplifier, the second input of the second summing circuitry coupled to the output of the slope compensation circuitry, and the output of the second summing circuitry coupled to the first input of the modulator.

6. The circuit of claim 5, the modulator comprising:
a comparator having a first input, a second input, and an output, the first input of the comparator forming the first input of the modulator, the second input of the comparator forming the second input of the modulator; and
driver logic circuitry having an input, a first output, and a second output, the input of the driver logic circuitry coupled to the output of the comparator, the first output of the driver logic circuitry forming the first output of the modulator, the second output of the driver logic circuitry forming the second output of the modulator.

7. The circuit of claim 1, wherein the modulator is coupled in a first feedback path including the current feedback terminal and the first input of the modulator,
wherein the error amplifier and the average current balancing circuitry are coupled in a second feedback path including the voltage feedback terminal, the first input of the error amplifier, the output of the error amplifier, the compensation terminal, the first input of the average current balancing circuitry, the output of the average current balancing circuitry, and the second input of the modulator, and
wherein the average current balancing circuitry is coupled in a third feedback path including the current feedback terminal, the second input of the average current balancing circuitry, the output of the average current balancing circuitry, and the second input of the modulator.

8. The circuit of claim 1, further comprising:
a first transistor having a first terminal, a second terminal, and a control terminal, the control terminal of the first transistor coupled to the first output of the modulator; and
a second transistor having a first terminal, a second terminal, and a control terminal, the first terminal of the second transistor coupled to the second terminal of the first transistor, the control terminal of the second transistor coupled to the second output of the modulator.

9. A system comprising:
a voltage input terminal and a voltage output terminal;
a first switching circuit coupled to the voltage input terminal and the voltage output terminal;
a first inductor coupled to the first switching circuit;
a first current sensor coupled to the first inductor;
a first compensation terminal, a first current feedback terminal coupled to the first current sensor, a first voltage feedback terminal coupled to the voltage output terminal, and a first reference voltage terminal;
a first modulator having a first input, a second input, a first output, and a second output, the first input of the first modulator coupled to the first current feedback terminal, the first output of the first modulator coupled to a first control terminal of the first switching circuit, the second output of the first modulator coupled to a second control terminal of the first switching circuit;
a first error amplifier having a first input, a second input, and an output, the first input of the first error amplifier coupled to the first voltage feedback terminal, the second input of the first error amplifier coupled to the first reference voltage terminal, the output of the first error amplifier coupled to the first compensation terminal; and
first average current balancing circuitry having a first input, a second input, and an output, the first input of the first average current balancing circuitry coupled to the output of the first error amplifier and the first compensation terminal, the second input of the first average current balancing circuitry coupled to the first current feedback terminal, the output of the first average current balancing circuitry coupled to the second input of the first modulator.

10. The system of claim 9, further comprising:
a second switching circuit coupled to the voltage input terminal and the voltage output terminal;
a second inductor coupled to the second switching circuit;
a second current sensor coupled to the second inductor;
a second compensation terminal coupled to the first compensation terminal, a second current feedback terminal coupled to the second current sensor, a second voltage feedback terminal coupled to the voltage output terminal, and a second reference voltage terminal;
a second modulator having a first input, a second input, a first output, and a second output, the first input of the second modulator coupled to the second current feedback terminal, the first output of the second modulator coupled to a first control terminal of the second switching circuit, the second output of the second modulator coupled to a second control terminal of the second switching circuit;
a second error amplifier having a first input, a second input, and an output, the first input of the second error amplifier coupled to the second voltage feedback terminal, the second input of the second error amplifier coupled to the second reference voltage terminal, the output of the second error amplifier coupled to the second compensation terminal; and
second average current balancing circuitry having a first input, a second input, and an output, the first input of the second average current balancing circuitry coupled to the output of the second error amplifier and the second compensation terminal, the second input of the second average current balancing circuitry coupled to the second current feedback terminal, the output of the second average current balancing circuitry coupled to the second input of the second modulator.

11. The system of claim 10, wherein first inductor has first inductance, and wherein the second inductor has second inductance different than first inductance.

12. The system of claim 10, wherein the first current sensor includes a first current sense resistor having a first resistance, and wherein the second current sensor includes a second current sense resistor having a second resistance different than the first resistance.

13. The system of claim 9, the first average current balancing circuitry comprising:
summing circuitry having a first input, a second input, and an output, the first input of the summing circuitry coupled to the output of the first error amplifier and the first compensation terminal, the output of the summing circuitry coupled to the second input of the first modulator; and
peak tracking circuitry having an input and an output, the input of the peak tracking circuitry coupled to the first current feedback terminal, the output of the peak tracking circuitry coupled to the second input of the summing circuitry.

14. The system of claim 13, the first average current balancing circuitry further comprising:
averaging circuitry having an input and an output, the input of the averaging circuitry coupled to the first current feedback terminal; and
amplification circuitry having an input and an output, the input of the amplification circuitry coupled to the output of the averaging circuitry, the output of the amplification circuitry coupled to a third input of the summing circuitry.

15. A circuit comprising:
a compensation terminal, a current feedback terminal, a voltage feedback terminal, and a reference voltage terminal;
a modulator configured to receive a first feedback signal indicating a feedback current from the current feedback terminal, receive an adjusted compensation signal, and output a modulated signal based on the first feedback signal and the adjusted compensation signal;
an error amplifier configured to receive a second feedback signal indicating a feedback voltage from the voltage feedback terminal, receive a reference signal from the reference voltage terminal, and output a compensation signal at the compensation terminal based on a comparison between the second feedback signal and the reference signal; and
average current balancing circuitry configured to receive the compensation signal, receive the first feedback signal from the current feedback terminal, and output the adjusted compensation signal to the modulator based on the compensation signal and the first feedback signal.

16. The circuit of claim 15, the average current balancing circuitry comprising:
peak tracking circuitry configured to receive the first feedback signal and output an offset signal based on the first feedback signal; and
summing circuitry configured to receive the compensation signal, receive the offset signal from the peak tracking circuitry, and output the adjusted compensation signal to the modulator based on the compensation signal and the offset signal.

17. The circuit of claim 16, wherein the peak tracking circuitry is configured to determine a peak of a ripple of the first feedback signal and output the offset signal based on the peak of the ripple.

18. The circuit of claim 16, the average current balancing circuitry further comprising:
averaging circuitry configured to receive the first feedback signal, determine an average of the first feedback signal, and output an averaged first feedback signal based on the average of the first feedback signal; and
amplification circuitry configured to receive the averaged first feedback signal and output an amplified averaged first feedback signal based on the averaged first feedback signal and a gain of the amplification circuitry,
wherein the summing circuitry is further configured to receive the amplified averaged first feedback signal and output the adjusted compensation signal to the modulator based on the amplified averaged first feedback signal, the compensation signal, and the offset signal.

19. The circuit of claim 18, wherein the summing circuitry is configured to output the adjusted compensation signal based on subtracting the amplified averaged first feedback signal from, and adding the offset signal to, the compensation signal.

20. The circuit of claim 18, wherein summing circuitry is configured to output the adjusted compensation signal based on subtracting the amplified averaged first feedback signal and the offset signal from the compensation signal.
